(19) United States
(12) Patent Application Publication
(10) Pub. No.: US 2025/0033296 A1
(43) Pub. Date: Jan. 30, 2025

(54) Device and method for preparing the weld region of the filling tube of a bag

(71) Applicant: Harro Höfliger Verpackungsmaschinen GmbH, Allmersbach im Tal (DE)

(72) Inventor: Jörg ROSENLAND, Auenwald (DE)

(73) Assignee: Harro Höfliger Verpackungsmaschinen GmbH, Allmersbach im Tal (DE)

(21) Appl. No.: 18/779,150

(22) Filed: Jul. 22, 2024

(30) Foreign Application Priority Data
Jul. 24, 2023 (EP) 23 187 209.4

(51) Int. Cl. B29C 65/78; B29C 65/00; B29C 65/08; B29L 23/00; B65B 51/14; B65B 67/12

(52) U.S. Cl. CPC B29C 65/7847; B29C 66/8511; B65B 51/14; B65B 67/12; B29C 65/08; B29L 2023/00

(57) ABSTRACT

A device (10) for preparing the weld region of the filling tube (20) of a bag (12) has a holder (15) for the bag (12) and a suction tube (50), which has been inserted in the filling tube (20) of the bag (12). A clamping device (42. 44) is present, which can clamp the filling tube (20) or the bag (12).

### CROSS-REFERENCE TO RELATED APPLICATION

This application claims the benefit of European Patent Application EP 23 187 209.4, filed on Jul. 24, 2023, the contents of which is incorporated in its entirety.

### TECHNICAL FIELD

The application relates to a device and a method for preparing the weld region of the filling tube of a bag, in particular an infusion bag. The infusion bag may be a bag with only one chamber, or with multiple chambers. Bags with multiple chambers may, for example, also comprise a powder and a liquid chamber.

### BACKGROUND

In general, it is necessary to fill infusion bags under specific conditions (referred to as “low bioburden” or through to aseptic conditions), since the contents of the infusion bags are supplied to a patient and therefore should not be contaminated. In the case of oxygen-sensitive contents, in particular in the case of cancer drugs or in the case of parenteral nutrition infusions, it may be necessary to fill the infusion bag under inert gas, since the liquid to be decanted must not come into contact with atmospheric oxygen. Nitrogen is generally used as insert gas. Sterilization after the filling operation is possible for some contents. In this case, an aseptic production process is not required. If, by contrast, subsequent sterilization is not possible, it is necessary to carry out an aseptic production process.

The bag generally has a filling tube, through which the bag can be filled. For this purpose, a metering needle is inserted into the filling tube. The outer contour of the metering needle may have at least one contour feature, which causes the elastic filling tube to be widened from the inside. The filling tube thereupon seals itself against the metering needle owing to its residual stress. Such sealing of the filling tube against the metering needle is necessary in order that no liquid can pass between the metering needle and the filling tube during the metering operation. While the bag is being filled, opposing forces can arise. The filling tube must therefore be stretched against the contour features so tightly that the forces exerted by the material stress are greater than the forces exerted by the liquid. If the filling tube is pulled off of the metering needle after the infusion bag has been completely filled, the length of the filling tube is generally stretched to a relatively great extent in the process. Subsequently, the filling tube abruptly contracts again. This can lead to product being splashed into the surrounding area; it is also possible for the inner side of the filling tube to be contaminated. Even if the filling tube is slid off of the metering needle often and actively, the stresses can cause similar effects and, as a result, contamination as well.

Even if the metering needle is pulled out of the filling tube, it is very likely that the inner side of the filling tube becomes wetted with the liquid to be decanted. Small droplets of the liquid may remain even on the end edge of the filling tube.

In order to prevent the liquid present in the bag being drawn into the filling tube after the end of the filling operation, it is possible to firstly perform a brief after-gassing operation. If use is made of a metering valve with ports both for the liquid and for an inert gas, this is fundamentally possible. If, by contrast, active after-gassing is not performed during the metering operation, it is necessary to ensure in another way that the metering tube is vented. This can be difficult, in particular in the event of filling by means of single-use components.

An alternative device which makes it easier to pull the metering needle out of the filling tube is described in EP 22 195 250.0.

Fundamentally, it is important that no liquid is present in the end region of the filling tube. The liquid residues in the end region of the filling tube can make it harder to subsequently close the bag. Thus, for example, welding by means of high-frequency welding methods can result in discharges, which can also take place inside the filling tube. If welding is performed beyond the tube end, the risk of such discharges occurring is again considerably increased. Furthermore, discharges can also occur when liquid residues are pressed outwards by the contact pressure of the welding jaws. Leaks in the bag might also occur, and this would lead to the corresponding product being rejected. This can become a problem in particular in the case of protein-containing liquids. Protein-containing liquids can make secure welding harder, since the proteins form a barrier layer.

In the prior art, the weld is placed in the region of the moist filling tube, irrespective of the tube material, the liquid and the selected welding method (generally an ultrasonic welding method or high-frequency welding method). The liquid might even pass through the weld if the liquid level rises into the filling tube. Although such a weld is effective, it depends, among other things, on the tube material, the type of liquid, the selected welding method and the time available for welding.

### SUMMARY

The application presents a device and a method for preparing the weld region of the filling tube of a bag which make it possible to weld the filling tube as securely and easily as possible. This is achieved by the subject matter as claimed.

The device for preparing the weld region of the filling tube of a bag has a holder for the bag. A suction tube is present which can be inserted into the filling tube of the bag. Furthermore, a clamping device is present, which can clamp the filling tube or the bag. The device makes it possible to reduce the moisture inside the filling tube in the weld region such that the weld can be placed exactly without having to fear leaks.

The clamping device may preferably be present between the free end of the suction tube and the bag. This makes it possible for the clamping device to clamp the filling tube. As an alternative, the clamping device may also be present in the upper region of the bag. This makes it possible for the bag to be clamped above the liquid already present in the bag.

In the method for preparing the weld region of the filling tube of a bag, the filling tube or the bag is clamped. A suction tube is inserted into the filling tube. This suction tube extracts the liquid remaining in the filling tube by suction. The clamping of the filling tube or the bag makes it possible to prevent the liquid present in the bag from also being extracted by suction.

As a result of high air speeds during the extraction by suction, product residues are thus removed from the region to be welded to a sufficient extent. In this way, not only can the risk of discharges be avoided, but at the same time also the influence of the liquid present in the bag on the weld quality is reduced such that it is possible to achieve a good weld quality. In particular in the case of protein-containing products, the device and the method as disclosed herein can thus make a significant difference.

It fundamentally is not important whether firstly the suction tube is inserted into the filling tube or whether firstly the filling tube or the bag is clamped at the desired location. The extraction of the liquid remaining in the filling tube by suction should, however, take place only after the filling tube or the bag is clamped, so that desired product is not inadvertently removed from the bag again.

With preference, the filling tube or the bag can be clamped in a first step. In this case, the extraction of the liquid remaining in the filling tube by suction can take place already during the insertion of the suction tube. This enables particularly effective and rapid drying of the inner walls of the filling tube. After the suction tube has been inserted, the suction tube can remain inside the filling tube for a certain period of time, while the extraction by suction is continued.

In general, the filling tube is filled from above, and therefore the filling tube is arranged on the upper edge of the bag. Therefore, the suction tube is generally also introduced into the filling tube from above. Accordingly, the clamping device is arranged a little underneath the free end of the suction tube.

In order to be able to optimally dry the free end of the filling tube, a peripheral intermediate space may be present between the outer wall of the suction tube and the inner wall of the filling tube. In this way, it is also possible to optimally treat that region of the filling tube in which the suction tube is located. Furthermore, it is also possible to remove droplets from the edge of the filling tube.

The device may preferably have a sealing device, which is arranged between the clamping device and the free end of the filling tube. Such a sealing device may in particular have two sealing jaws, between which the sealing seam can be formed.

In this case, the filling tube can be welded directly after the removal of the suction tube. The filling tube may still be clamped, and therefore re-contamination of the inner walls of the filling tube can be ruled out.

### BRIEF DESCRIPTION OF THE DRAWINGS

The invention will be described and explained in more detail below on the basis of the exemplary embodiments shown in the drawings.

FIG. 1 shows a schematic illustration of the device for preparing the weld region of the filling tube of a bag before the start of the preparation method.

FIG. 2 shows a schematic illustration according to FIG. 1 after the filling tube has been clamped.

FIG. 3 shows a schematic illustration according to FIG. 2 while the suction tube is being inserted and at the same time the liquid remaining in the filling tube is being extracted by suction.

FIG. 4 shows a schematic illustration according to FIG. 3 after the liquid has been successfully extracted by suction.

FIG. 5 shows a schematic illustration according to FIG. 4 after the suction tube has been removed.

FIG. 6 shows a schematic illustration according to FIG. 5 while the filling tube is being welded.

### DETAILED DESCRIPTION

The device 10 for preparing the weld region of the filling tube of a bag is schematically illustrated in FIGS. 1 to 6. The device 10 has a holder 15, which can be used to hold a bag 12, which may be in particular an infusion bag 12. The bag 12 is held substantially suspended by the holder 15, and therefore the bag 12 is aligned approximately vertically.

The bag 12 has a filling tube 20, which is arranged on the upper edge of the bag 12. The filling tube 20 may be in one piece with the bag 12, or be fastened to the bag 12. The bag 12 was already filled with at least one liquid 22 at an upstream processing station. As a result of filling the bag with the liquid 22, droplets 26 of the liquid 22 remain on the inner side 24 of the filling tube 20 at two locations in the present example. These remaining droplets 26 of liquid are in the weld region 28 of the filling tube 20. In the present example, a further droplet 32 of the liquid 22 is also located on the peripheral edge 30 of the filling tube 20.

The droplets 26 may make it harder to produce the sealing seam 34 and adversely affect the quality of the sealing seam 34. Such droplets 26 should therefore be removed before the weld 34 is created. The droplets 32 on the edge 30 of the filling tube 20 may, after the sealing seam 34 is produced, lead to contamination of the outer side of the bag 12 or of the filling tube 20, and therefore these droplets 32 should also be removed as far as possible.

The device 10 therefore has a clamping device 40 in the region of the filling tube 20. In the present example, the clamping device 40 has two clamping jaws 42, 44. The clamping jaws 42, 44 make it possible to tightly clamp the filling tube 20. As a result, no further liquid 22 can pass from the bag 12 into the filling tube 20; at the same time, air and liquid can also no longer flow out of the filling tube 20 into the bag 12. In the present example, the clamping device 40 is relatively close to the upper edge of the bag 12. Depending on the length of the filling tube 20, the clamping device 40 can also be further away from the upper edge of the bag 12.

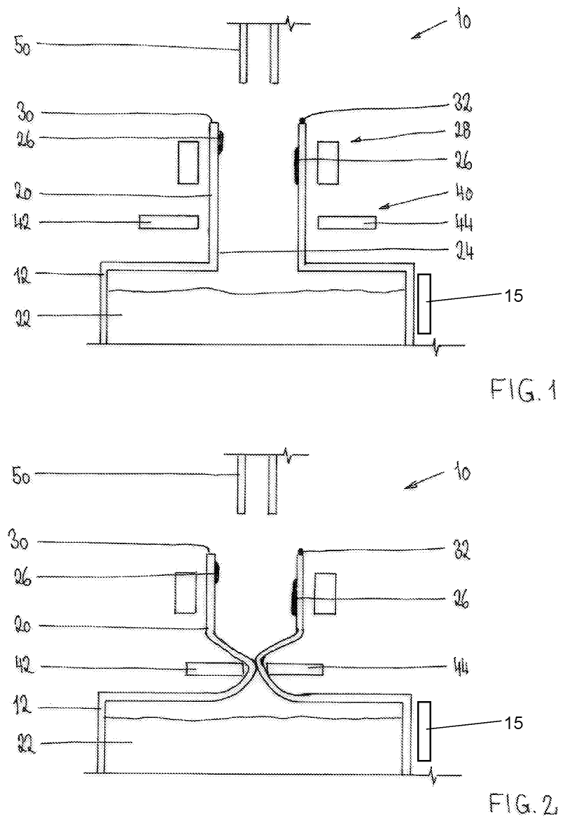

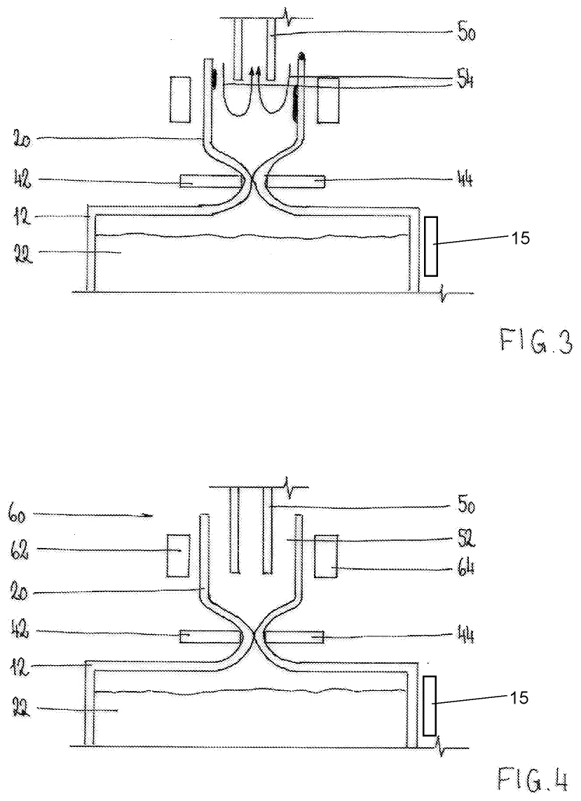

For this purpose, the device 10 has a suction tube 50, which firstly is present outside the filling tube 20 (see FIG. 1). After the bag 12 has been filled with the liquid 22, in the present example firstly the filling tube 20 is clamped by the clamping device 40 (see FIG. 2). Then, the suction tube 50 is inserted at least a little way into the filling tube 20 (see FIG. 3). In the process, the suction tube 50 extracts air by suction. This can be effected for example by a negative-pressure generator, which is connected to the suction tube 50. The suction tube 50 is configured such that a peripheral intermediate space 52 is formed between the outer side of the suction tube 50 and the inner side 24 of the filling tube 20. Through this intermediate space 52, the air is firstly drawn through the filling tube 20 towards the clamping device 40 and then the air is extracted from the filling tube 20 by suction through the suction tube 50. This air stream 54 carries along the droplets 26 of liquid remaining in the filling tube 20 and removes them from the filling tube 20. In the present example, the extraction by suction is started as early as during the insertion of the suction tube 50 into the filling tube 20. This makes it possible to remove even droplets 32 of liquid that are present on the peripheral edge 30. After the suction tube 50 has been completely inserted into the filling tube 20, the extraction by suction can still be continued for a certain period of time until no more liquid residues remain on the inner side 24 of the filling tube 20 (see FIG. 4). The duration of the extraction by suction may be varied depending on the liquid 22 and the material of the filling tube 20.

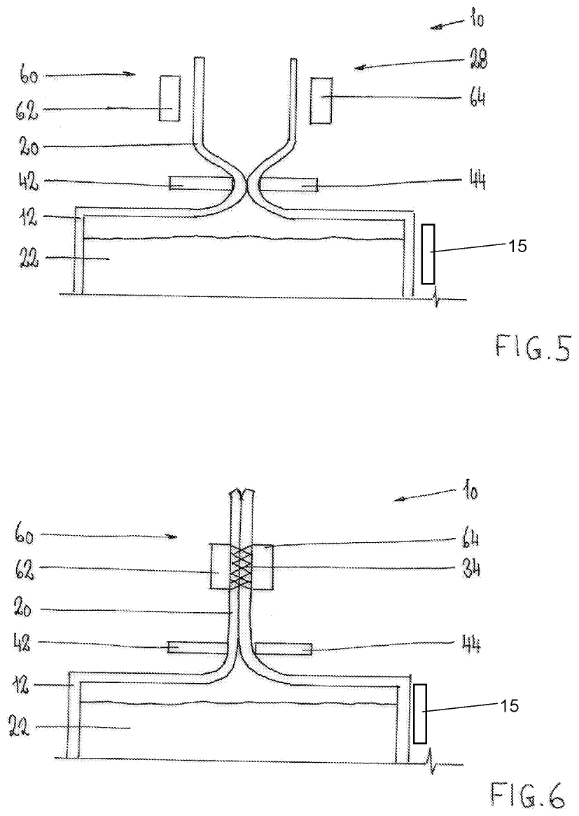

The suction tube 50 may then be removed from the filling tube 20 again (see FIG. 5). In so doing, the filling tube 20 should initially still be kept clamped by the clamping device 40, in order to prevent re-contamination of the filling tube 20.

The filling tube 20 can then be closed by means of a sealing seam 34. In the present example, this can also be effected by means of the device 10. The device 10 has a sealing device 60 for this. The sealing device 60 has two sealing jaws 62, 64 in the present example. The sealing device 60 is arranged between the clamping device 40 and the peripheral edge 30 of the filling tube 20. The sealing seam 34 can therefore be created directly after the removal of the suction tube 50 (see FIG.6). As a result, liquid residues are largely removed from the inner side 24 of the filling tube 20, with the result that a high-quality sealing seam 34 can be created.

As an alternative, the sealing seam 34 may also be created in a downstream processing station. In this case, it can be expedient to design the clamping device 40 such that the filling tube 20 can be kept clamped even while the bag 12 is being transported from the device 10 to this downstream processing station. This can prevent re-contamination of the inner side of the filling tube 20.

The scaling seam 34 may—as illustrated in the drawings—be placed merely in the central region of the filling tube 20. As an alternative, the sealing seam 34 could also extend up to the lower and/or upper edge of the filling tube 20.

What is claimed is:

1. A device (10) for preparing a weld region of a filling tube (20) of a bag (12), comprising:
a holder (15) for the bag (12);
a suction tube (50), configured to be inserted into the filling tube (20) of the bag (12); and
a clamping device (40), configured to clamp the filling tube (20) or the bag (12).

2. The device according to claim 1,
wherein the filling tube (20) is designed to be clamped between a free end of the suction tube (50) and the bag (12).

3. The device according to claim 1,
wherein a peripheral intermediate space (52) is formed between an outer wall of the suction tube (50) and an inner wall (24) of the filling tube (50).

4. The device according to claim 2,
further comprising a sealing device (60) arranged between the clamping device (40) and the free end (32) of the filling tube (20).

5. The device according to claim 4,
wherein the sealing device (60) has at least two sealing jaws (62, 64).

6. A method for preparing a weld region of a filling tube (20) of a bag (12), comprising:
a) clamping the filling tube (20) or the bag (12);
b) inserting a suction tube (50) into the filling tube (20) of the bag (12); and
c) extracting liquid (26, 32) remaining in the filling tube (20) by suction through the suction tube (50).

7. The method according to claim 6,
wherein clamping the filling tube (20) or the bag (12) comprises clamping the filling tube (20) between the bag (12) and a free end of the suction tube (50).

8. The method according to claim 6, wherein steps a) and b) can be carried out in any order.

9. The method according to claim 6,
wherein method step a) is carried out first, and
wherein the liquid (26, 32) remaining in the filling tube (20) is extracted by suction starting during the inserting of the suction tube (50).

10. The method according to claim 9,
wherein the liquid (26, 32) remaining in the filling tube (20) continues to be extracted by suction for a predetermined period of time after the suction tube (50) has been inserted.

11. The method according to claim 6, further comprising:
removing the suction tube (50) from the filling tube (20); and
welding the filling tube (20) between a clamped region and a free end (30) of the filling tube (20).
